(19) United States
(12) Patent Application Publication
(10) Pub. No.: US 2021/0390839 A1
(43) Pub. Date: Dec. 16, 2021

(54) GLUE INJECTING DEVICE AND APPARATUS HAVING THE SAME

(71) Applicant: TRIPLE WIN TECHNOLOGY(SHENZHEN) CO.LTD., Shenzhen (CN)

(72) Inventor: JING-WEI HAO, Shenzhen (CN)

(21) Appl. No.: 17/003,028

(22) Filed: Aug. 26, 2020

(30) Foreign Application Priority Data
Jun. 12, 2020 (CN) 202021082763.2

(51) Int. Cl. G08B 21/18; G01F 23/00; G08B 7/06

(52) U.S. Cl. CPC G08B 21/18; G08B 7/06; G01F 23/0015

(57) ABSTRACT

A glue injecting device includes a glue container, a piston, a magnetic component, and a detection alarm assembly. The glue container defines a cavity for receiving glue materials and an outlet opening communicating with the cavity. The piston is received in the cavity for extruding the glue materials from the outlet opening. The magnetic component is arranged on the piston. The detection alarm assembly comprises an electromagnetic sensor and an alarm. The electromagnetic sensor configured to detect a position of the magnetic component is sleeved on the glue container and is close to the outlet opening, the alarm is electrically connected to the electromagnetic sensor and is configured to issue an alarm when the position of the magnetic component detected by the electromagnetic sensor is flush with the electromagnetic sensor. The disclosure also provides an apparatus having the glue injecting device.

### FIELD

The subject matter herein generally relates to a glue injecting device and an apparatus having the glue injecting device.

### BACKGROUND

Glue injecting devices includes a glue container to install glue materials. However, the amount of glue materials in the glue container needs to be manually observed to facilitate timely replenishment or replacement.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of an embodiment of a glue injecting device.

FIG. 2 is a state diagram of the glue injecting device of FIG. 1.

FIG. 3 is a diagram of another embodiment of a glue injecting device.

FIG. 4 is a diagram of an embodiment of an apparatus.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

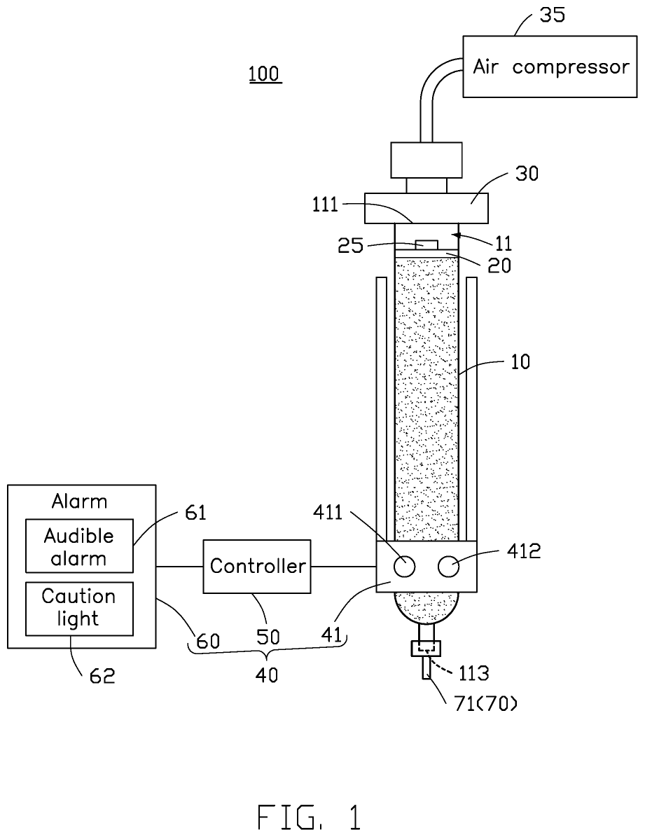

FIG. 1 illustrates an embodiment of a glue injecting device 100. The glue injecting device 100 includes a glue container 10, a piston 20, a magnetic component 25, a pneumatic valve 30, and a detection alarm assembly 40.

The glue container 10 defines a cavity 11 for receiving glue materials, an air inlet opening 111 communicating with the cavity 11, and an outlet opening 113 communicating the cavity 11.

In at least one embodiment, the glue container 10 may be approximately in the shape of a hollow cylinder. The air inlet opening 111 and the outlet opening 113 may be disposed at opposite ends of the glue container 10. The glue container 10 includes an upper wall (not shown), a bottom wall (not labeled) facing away from the upper wall, and a side wall (not labeled) connecting the upper wall and the bottom wall. The air inlet opening 111 is formed on the upper wall. The outlet opening 113 formed on the bottom wall.

The piston 20 is received in the cavity 11 for pushing the glue materials in the cavity 11. The piston 20 slides long the cavity 11 between the air inlet opening 111 and the outlet opening 113.

The magnetic component 25 is arranged on a surface of the piston 20 facing away from the outlet opening 113 to move with the piston 20. In at least one embodiment, the magnetic component 25 may be a permanent magnet.

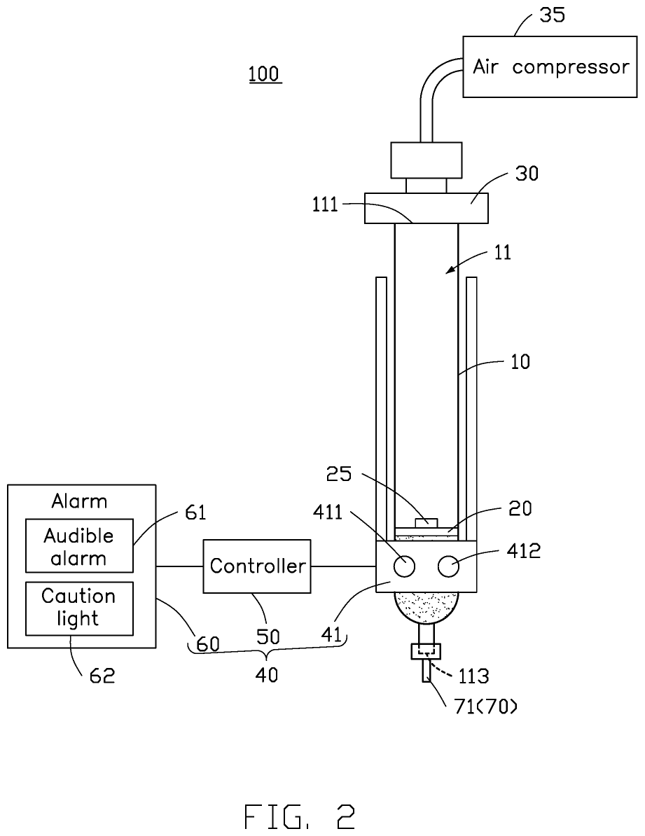

Referring to FIG. 2, the pneumatic valve 30 is mounted at the end of the glue container 10 with the air inlet opening 111 for communicating with an air compressor 35 and the cavity 11. The cavity 11 is pressurized by the air compressor 35 to push the piston 20 to slide toward the outlet opening 113, thereby squeezing the glue materials between the piston 20 and the outlet opening 113 to be extruded from the outlet opening 113.

The detection alarm assembly 40 includes an electromagnetic sensor 41, a controller 50, and an alarm 60.

The electromagnetic sensor 41 is sleeved on the side wall of the glue container 10 and located between the air inlet opening 111 and the outlet opening 113 for detecting a position of the magnetic component 25. In at least one embodiment, the electromagnetic sensor 41 is arranged close to the outlet opening 113. The electromagnetic sensor 41 and the alarm 60 are electrically connected to the controller 50 respectively. When the magnetic component 25 is flush with the electromagnetic sensor 41, the electromagnetic sensor 41 transmits a signal to the controller 50, The controller 50 receives the signal and controls the alarm 60 to issue an alarm to remind to replenish glue materials or to directly replace the glue container 10.

In at least one embodiment, the alarm 60 includes an audible alarm 61 and a caution light 63. When an alarm is required, the audible alarm 61 sounds, and the caution light 63 flashes. The audible alarm 61 may be a buzzer. In at least one embodiment, the alarm 60 may be an audible alarm 61 or a caution light 63.

In at least one embodiment, the electromagnetic sensor 41 and the controller 50 may transmit signals wirelessly. A signal transmission between the controller 50 and the alarm 60 may also be performed in a wireless manner.

In at least one embodiment, the electromagnetic sensor 41 may slide along the side wall of the glue container 10 between the air inlet opening 111 and the outlet opening 113 to adjust a distance between the electromagnetic sensor 41 and the outlet opening 113, thereby adjusting a height of a warning line of the glue materials in the glue container 10.

The glue injecting device 100 may further include a dispenser 70. The dispenser 70 is mounted at the end of the glue container 10 with the outlet opening 113. The dispenser 70 communicates with the outlet opening 113.

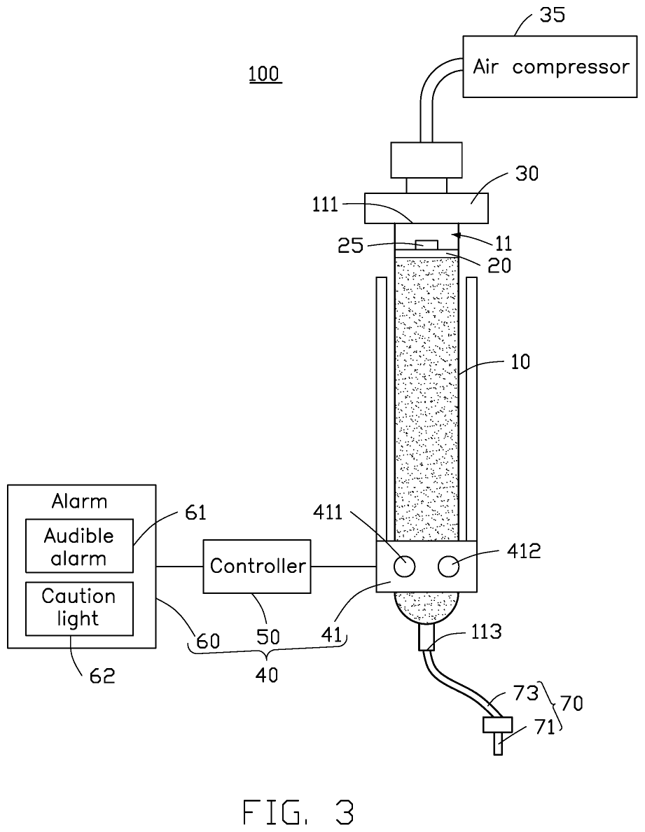

In at least one embodiment, the dispenser 70 may include a dispensing nozzle 71. The dispensing nozzle 71 may be directly installed at the end of the glue container 10 with the outlet opening 113. Referring to FIG. 3, the dispenser 70 may further include a glue pipe 73. The dispensing nozzle 71 communicates with the outlet opening 113 through the glue pipe 73.

In at least one embodiment, the electromagnetic sensor 41 may include a first indicator light 411 and a second indicator light 412. When the magnetic component 25 is located between the air inlet opening 111 and the electromagnetic sensor 41, the first indicator light 411 flashes. When the magnetic component 25 is flush with the electromagnetic sensor 41 or located between the outlet opening 113 and the electromagnetic sensor 41, the second indicator light 412 flashes.

In at least one embodiment, the detection alarm assembly 40 may be integrated by the electromagnetic sensor 41, the controller 50, and the alarm 60.

The above glue injecting device 100 realizes the monitoring od the amount of the glue materials in the glue container 10 through a cooperation of the magnetic component 25 and the electromagnetic sensor 41. When the magnetic component 25 is flush with the electromagnetic sensor 41, an alarm is issued by the alarm 60.

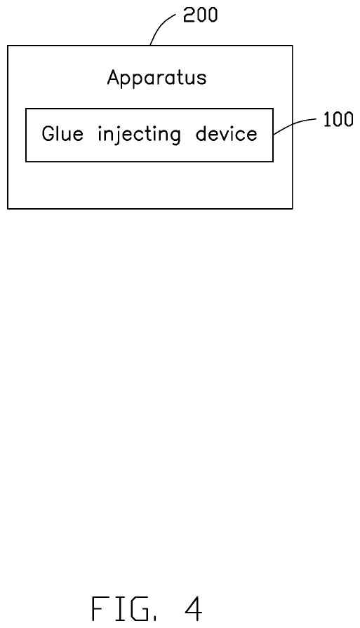

The above glue injecting device 100 may be applied in an apparatus 200 (shown in FIG. 4) that has glue injecting requirements or glue dispensing requirements.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A glue injecting device comprising:
a glue container defining a cavity for receiving glue materials and further defining an outlet opening communicating with the cavity;
a piston movably received in the cavity for extruding the glue materials from the outlet opening;
a magnetic component arranged on a surface of the piston facing away from the outlet opening; and
a detection alarm assembly;
wherein the detection alarm assembly comprises an electromagnetic sensor and an alarm, the electromagnetic sensor is sleeved on an outside wall of the glue container and is close to the outlet opening, the electromagnetic sensor is configured to detect a position of the magnetic component, the alarm is electrically connected to the electromagnetic sensor and is configured to issue an alarm when the position of the magnetic component detected by the electromagnetic sensor is flush with the electromagnetic sensor.

2. The glue injecting device of claim 1, wherein the electromagnetic sensor slides along the outside wall of the glue container to adjust a distance between the electromagnetic sensor and the outlet opening.

3. The glue injecting device of claim 1, wherein the glue container further defines an air inlet opening communicating with the cavity, the piston moves between the air inlet opening and the outlet opening, the electromagnetic sensor is located between the air inlet opening and the outlet opening.

4. The glue injecting device of claim 3, wherein the glue injecting device further comprise a pneumatic valve and an air compressor, the pneumatic valve communicates with the air inlet opening and the air compressor, the air compressor is configured to drive the piston.

5. The glue injecting device of claim 1, wherein the detection alarm assembly further comprises a controller, the electromagnetic sensor and the alarm are electrically connected to the controller respectively, the controller is configured to receive a signal from the electromagnetic sensor and control the alarm to issue the alarm.

6. The glue injecting device of claim 1, wherein the alarm comprises an audible alarm and a caution light.

7. The glue injecting device of claim 1, wherein the magnetic component is permanent magnet.

8. The glue injecting device of claim 1, wherein a first indicator light and a second indicator light are arranged on the electromagnetic sensor, the first indicator light is configured to indicate that the magnetic component is located on a side of the electromagnetic sensor facing away from the outlet opening, the second indicator light is configured to the magnetic component is flush with the electromagnetic sensor or is located between the electromagnetic sensor and the outlet opening.

9. An apparatus comprising:
a glue injecting device comprising:
a glue container defining a cavity for receiving glue materials and further defining an outlet opening communicating with the cavity;
a piston movably received in the cavity for extruding the glue materials from the outlet opening;
a magnetic component arranged on a surface of the piston facing away from the outlet opening; and
a detection alarm assembly;
wherein the detection alarm assembly comprises an electromagnetic sensor and an alarm, the electromagnetic sensor is sleeved on an outside wall of the glue container and is close to the outlet opening, the electromagnetic sensor is configured to detect a position of the magnetic component, the alarm is electrically connected to the electromagnetic sensor and is configured to issue an alarm when the position of the magnetic component detected by the electromagnetic sensor is flush with the electromagnetic sensor.

10. The apparatus of claim 9, wherein the electromagnetic sensor slides along the outside wall of the glue container to adjust a distance between the electromagnetic sensor and the outlet opening.

11. The apparatus of claim 9, wherein the glue container further defines an air inlet opening communicating with the cavity, the piston moves between the air inlet opening and the outlet opening, the electromagnetic sensor is located between the air inlet opening and the outlet opening.

12. The apparatus of claim 11, wherein the glue injecting device further comprise a pneumatic valve and an air compressor, the pneumatic valve communicates with the air inlet opening and the air compressor, the air compressor is configured to drive the piston.

13. The apparatus of claim 9, wherein the detection alarm assembly further comprises a controller, the electromagnetic sensor and the alarm are electrically connected to the controller respectively, the controller is configured to receive a signal from the electromagnetic sensor and control the alarm to issue the alarm.

14. The apparatus of claim 9, wherein the alarm comprises an audible alarm and a caution light.

15. The apparatus of claim 9, wherein the magnetic component is permanent magnet.

16. The apparatus of claim 9, wherein a first indicator light and a second indicator light are arranged on the electromagnetic sensor, the first indicator light is configured to indicate that the magnetic component is located on a side of the electromagnetic sensor facing away from the outlet opening, the second indicator light is configured to the magnetic component is flush with the electromagnetic sensor or is located between the electromagnetic sensor and the outlet opening.
